(19) United States
(12) Patent Application Publication
(10) Pub. No.: US 2009/0311601 A1
(43) Pub. Date: Dec. 17, 2009

(54) NEGATIVE ELECTRODE AND LITHIUM ION SECONDARY BATTERY

(76) Inventors: Katsumi Kashiwagi, Nara (JP); Masaya Ugaji, Osaka (JP)

Correspondence Address: MCDERMOTT WILL & EMERY LLP, 600 13TH STREET, NW, WASHINGTON, DC, 20005-3096, US

(21) Appl. No.: 12/481,279

(22) Filed: Jun. 9, 2009

(30) Foreign Application Priority Data
Jun. 16, 2008 (JP) 2008-156930

(51) Int. Cl. H01M 4/48; H01M 4/02

(52) U.S. Cl. 429/218.1; 429/209

(57) ABSTRACT

In the negative electrode of the present invention, the negative electrode current collector includes a substrate and a plurality of protrusions, and the protrusions are formed on the surface of the substrate. The negative electrode active material layer includes a columnar active material layer and a stacked active material layer containing an alloy-based negative electrode active material. The columnar active material layer includes one or more columns that extend outwardly from the surface of the protrusions. The stacked active material layer is formed by stacking a thin film in a zigzag manner on the substrate surface between the protrusions. By using this negative electrode, negative electrode deformation, and separation of the negative electrode active material layer from the negative electrode current collector are suppressed, and a lithium ion secondary battery that has excellent charge and discharge cycle performance and output performance can be obtained.

### FIELD OF THE INVENTION

The present invention relates to a negative electrode and a lithium ion secondary battery. Further particularly, the present invention mainly relates to an improvement in a negative electrode.

### BACKGROUND OF THE INVENTION

Lithium ion secondary batteries are widely used as a power source for portable electronic devices, because of their high capacity and high energy density, and because their size and weight are easily reduced. Such portable electronic devices include mobile phones, personal digital assistants (PDAs), notebook personal computers, camcorders, and portable game devices. Typical lithium ion secondary batteries include a positive electrode containing a lithium cobalt compound as the positive electrode active material, a separator of polyolefin porous film, and a negative electrode containing a carbon material such as graphite as the negative electrode active material.

Recently, small electronic devices are becoming multi-functional, and the amount of their electric power consumption is increasing. With such an increase in power consumption, further high capacity and high output are demanded for lithium ion secondary batteries as well. Thus, the development of, for example, a high capacity negative electrode active material has been actively conducted. Among the high capacity negative electrode active materials, an alloy-based negative electrode active material has been gaining attention. The alloy-based negative electrode active material is a material that absorbs lithium by being alloyed with lithium, and absorbs and desorbs lithium under a negative electrode potential. Examples of the alloy-based negative electrode active material include silicon, tin, their oxides, and compounds and alloys containing silicon and tin. Because the alloy-based negative electrode active material has a high discharge capacity, such an active material is effective in increasing the capacity of lithium ion secondary batteries. For example, the theoretical discharge capacity of silicon is about 4199 mAh/g, which is about eleven times the theoretical discharge capacity of graphite.

The alloy-based negative electrode active material repeatedly undergoes comparatively large volume changes (expansion and contraction) with the absorption and desorption of lithium, and generates a large amount of stress at that time. Therefore, in a lithium ion secondary battery using the alloy-based negative electrode active material, as the number of charge and discharge times increases, deformation, warping, and the like easily occur not only to the negative electrode current collector but also to the entire negative electrode due to the volume change in the alloy-based negative electrode active material. Also, partial separation of the negative electrode active material layer from the negative electrode current collector easily occurs. As a result, the charge and discharge cycle performance of the battery declines, and the service life of the battery shortens.

In view of such problems, Japanese Laid-Open Patent Publication No. 2002-313319 (hereinafter, referred to as “Patent Document 1”) has proposed a negative electrode in which metal particles are attached to the surface of metal foil to serve as protrusions, and columns are formed on the protrusions. The columns contain an alloy-based negative electrode active material, and the cross sectional diameter thereof increases as the distance from the metal foil increases. The cross sectional diameter is the diameter of a cross section of a column in the direction perpendicular to its axis. A void is formed between one column and another column adjacent thereto at a portion in proximity to the metal foil surface.

Because the metal particles are attached to the metal foil surface by electrolytic deposition in the negative electrode of Patent Document 1, the bonding strength between the metal particles and the metal foil is low. Therefore, the metal particles are easily separated from the metal foil due to the stress generated along with the volume change in the alloy-based negative electrode active material. Furthermore, because the shape and size of the metal particles attached to the metal foil surface vary, the bonding strength between the metal particles and the column becomes non-uniform. Also, at the portion of the column away from the metal foil, the columns are in contact with each other. Thus, despite the void provided between the columns, the stress generated along with the volume change in the alloy-based negative electrode active material cannot be eased sufficiently, making it easy for the columns to separate from the metal particles. Therefore, the lithium ion secondary battery including the negative electrode of Patent Document 1 cannot maintain high quality charge and discharge cycle performance for a long period of time.

Japanese Laid-Open Patent Publication No. 2005-196970 (hereinafter, referred to as “Patent Document 2”) has proposed a negative electrode including a metal foil with an average surface roughness Ra of 0.01 to 1 μm, and one or more columns formed on the metal foil surface and containing an alloy-based negative electrode active material. The columns are formed so that their axes tilt with respect to the direction perpendicular to the metal foil surface. Because the negative electrode in Patent Document 2 is formed so that the columns are tilted, the area of the column facing the positive electrode is large. As a result, the utilization rate of the positive electrode active material and the negative electrode active material is increased and, in terms of improving the capacity retention rate of the battery, the negative electrode of Patent Document 2 is superior to the negative electrode of Patent Document 1. However, because the columns are in contact with each other in Patent Document 2 as well, the stress generated along with the volume change in the alloy-based negative electrode active material cannot be eased sufficiently, leaving a fear that the columns will become separated from the metal foil.

Japanese Laid-Open Patent Publication No. 2007-323990 (hereinafter, referred to as “Patent Document 3”) has proposed a negative electrode including a metal foil with one or more grooves regularly formed on the surface thereof, and columns formed in a region surrounded by the grooves on the metal foil surface. In Patent Document 3, the region surrounded by the grooves on the metal foil surface corresponds to a protrusion. The column contains an alloy-based negative electrode active material, and the axis thereof is tilted with respect to the direction perpendicular to the metal foil surface. One column and another column adjacent thereto are formed so as to be alienated from each other. Although the deformation and the like involved with the volume change in the alloy-based negative electrode active material is notably suppressed, and the separation of the columns from the metal foil is less in the negative electrode of Patent Document 3 compared with the negative electrode of Patent Document 1, there is still room for further improvement.

### BRIEF SUMMARY OF THE INVENTION

An object of the present invention is to provide a negative electrode in which deformation and separation of the active material layer are significantly reduced and high quality current collecting performance can be kept, and a lithium ion secondary battery that has high capacity and energy density, excellent charge and discharge cycle performance, and is capable of stably maintaining a high output for a long period of time.

The present invention provides a negative electrode including a negative electrode current collector and a negative electrode active material layer. In the negative electrode of the present invention, the negative electrode current collector includes a sheet substrate and a plurality of protrusions, and the protrusions are formed so as to project outwardly from at least one surface of the substrate. The negative electrode active material layer includes a columnar active material layer and a stacked active material layer. The columnar active material layer contains an alloy-based negative electrode active material, and is formed so as to extend outwardly from at least a portion of the surface of the protrusions. The stacked active material layer is formed by stacking an active material thin film including an alloy-based negative electrode active material in a zigzag manner on the surface of substrate between the protrusions that are adjacent to each other.

The columnar active material layer is preferably formed so as to extend outwardly from at least the entire face of a tip end portion of the protrusions and a portion of a side face of the protrusions. The columnar active material layer is preferably a stack of chunks including the alloy-based negative electrode active material.

The protrusions are preferably formed by plastic deformation of a metal sheet. The tip end portion of the protrusions in the direction of their projection is preferably a flat face substantially parallel to the surface of the substrate. The height of the protrusions is preferably 1 to 20 μm, and a cross sectional diameter of the protrusions is preferably 5 to 30 μm.

The alloy-based negative electrode active material is preferably at least one selected from the group consisting of an alloy-based negative electrode active material including silicon, and an alloy-based negative electrode active material including tin. The alloy-based negative electrode active material including silicon is preferably at least one selected from the group consisting of silicon, a silicon oxide, a silicon nitride, a silicon-containing alloy, and a silicon compound. The alloy-based negative electrode active material including tin is preferably at least one selected from the group consisting of tin, a tin oxide, a tin-containing alloy, and a tin compound.

The present invention also provides a lithium ion secondary battery including a positive electrode, a negative electrode, a separator, and a non-aqueous electrolyte. In the lithium ion secondary battery of the present invention, the positive electrode includes a positive electrode active material capable of absorbing and desorbing lithium, the negative electrode is the negative electrode of the present invention, the separator is disposed so as to be interposed between the positive electrode and the negative electrode, and the non-aqueous electrolyte has lithium ion conductivity.

In the negative electrode of the present invention, deformation and separation of the negative electrode active material layer (columns) from the negative electrode current collector are significantly reduced, even if volume changes in the alloy-based negative electrode active material occur along with charge and discharge and a large stress is generated. Such effects are maintained during the entire period of use of the battery. Therefore, the negative electrode of the present invention has a high capacity, and exhibits excellent current collecting performance for a long time.

In the lithium ion secondary battery including the negative electrode of the present invention, deformation of the negative electrode and separation of the negative electrode active material layer from the negative electrode current collector are significantly reduced, and the high quality current collecting performance of the negative electrode is maintained even with repeated charge and discharge cycles. Therefore, the lithium ion secondary battery of the present invention has a high battery capacity and energy density, excellent charge and discharge cycle performance, and long service life, and is capable of stably maintaining a high output for a long period of time.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a vertical cross sectional view schematically illustrating the configuration of a lithium ion secondary battery as an embodiment of the present invention.

FIG. 2 is a perspective view schematically illustrating the configuration of a relevant part (negative electrode current collector) of the lithium ion secondary battery shown in FIG. 1.

FIG. 3 is a vertical cross sectional view illustrating the configuration of a relevant part (negative electrode), with enlargement, of the lithium ion secondary battery shown in FIG. 1.

FIG. 4 is a vertical cross sectional view illustrating the configuration, with enlargement, of a relevant part (negative electrode active material layer) of the lithium ion secondary battery shown in FIG. 1.

FIG. 5 is a vertical cross sectional view illustrating the configuration of a relevant part, with enlargement, of the negative electrode active material layer shown in FIG. 4.

FIG. 6 is a vertical cross sectional view illustrating a method for producing a column.

FIG. 7 is a side view schematically illustrating the configuration of an electron beam deposition apparatus.

### DETAILED DESCRIPTION OF THE INVENTION

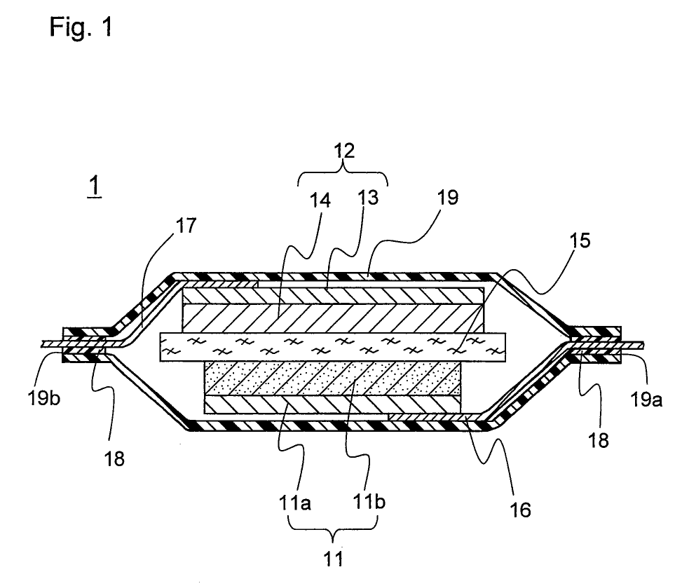

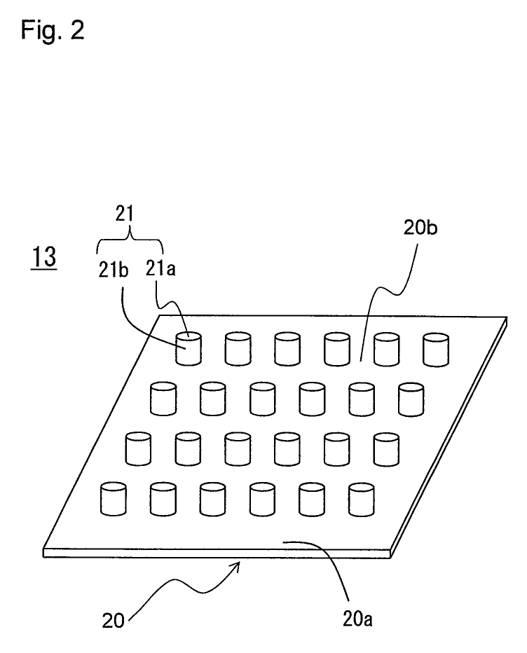

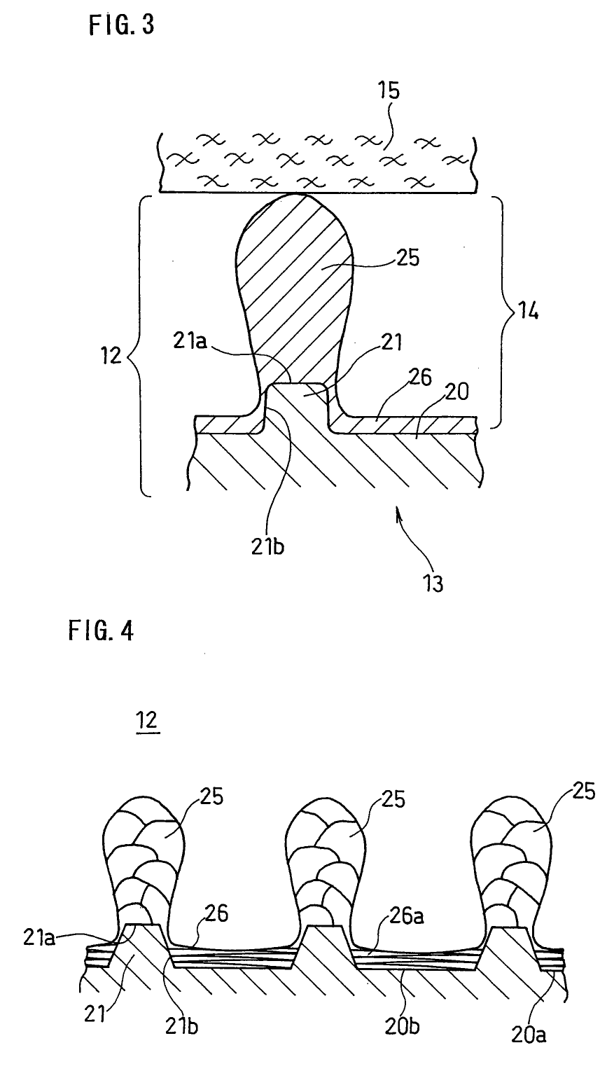

FIG. 1 is a vertical cross sectional view schematically illustrating the configuration of a lithium ion secondary battery 1 as an embodiment of the present invention. FIG. 2 is a perspective view schematically illustrating the configuration of a relevant part (negative electrode current collector 13) of the lithium ion secondary battery 1 shown in FIG. 1. FIG. 3 is a vertical cross sectional view illustrating the configuration of a relevant part (negative electrode 12), with enlargement, of the lithium ion secondary battery 1 shown in FIG. 1.

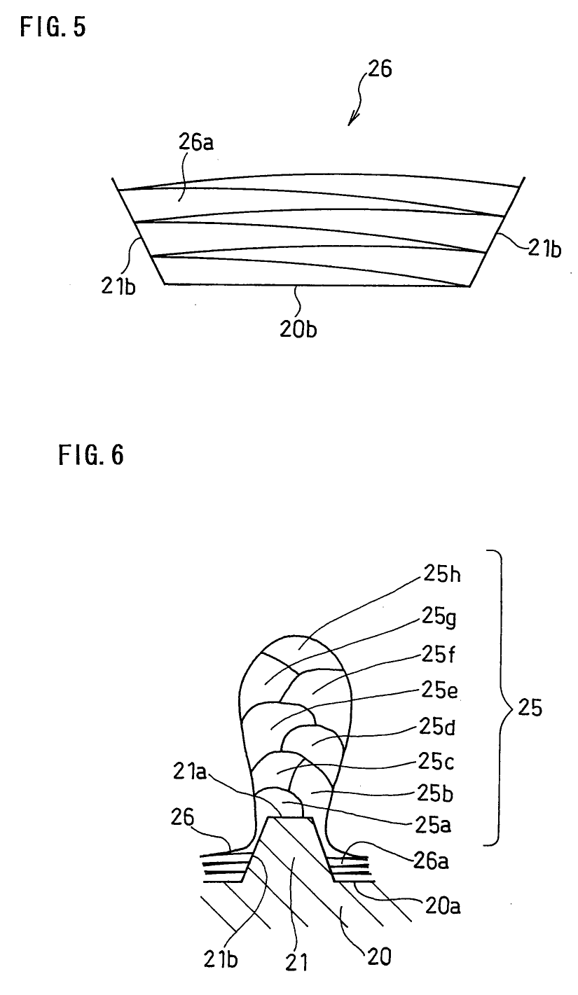

FIG. 4 is a vertical cross sectional view illustrating the configuration, with enlargement, of a relevant part (negative electrode active material layer 14) of the lithium ion secondary battery 1 shown in FIG. 1. FIG. 5 is a vertical cross sectional view illustrating the configuration of a relevant part (stacked active material layer 26), with enlargement, of a negative electrode active material layer 14 shown in FIG. 4. FIG. 6 is a vertical cross sectional view illustrating a method for producing a column 25. In FIG. 4 to FIG. 6, the hatching for the negative electrode active material layer 14 is omitted for simple illustration.

A lithium ion secondary battery 1 includes a positive electrode 11, a negative electrode 12, a separator 15, a positive electrode lead 16, a negative electrode lead 17, a gasket 18, and an outer case 19. The positive electrode 11 includes a positive electrode current collector 11a and a positive electrode active material layer 11b.

For the positive electrode current collector 11a, a conductive substrate can be used. The materials of the conductive substrate include metal materials such as stainless steel, titanium, aluminum, and aluminum alloys, and conductive resins. The conductive substrate includes a porous conductive substrate and a non-porous conductive substrate. The porous conductive substrate includes a mesh material, a net material, a punched sheet, a lath material, a porous material, a foam, a nonwoven fabric, and the like. The non-porous conductive substrate includes foil, sheet, film, and the like. The thickness of the conductive substrate is generally 1 to 50 μm, and preferably 5 to 20 μm.

The positive electrode active material layer 11b is provided, as shown in FIG. 1, on one surface of the positive electrode current collector 11a in the thickness direction thereof. The positive electrode active material layer 11b may be provided on both surfaces of the positive electrode current collector 11a in the thickness direction thereof. The positive electrode active material layer 11b includes a positive electrode active material, and may further include a conductive agent, a binder, and the like as necessary.

For the positive electrode active material, those commonly used in the art may be used, including, for example, a lithium-containing composite metal oxide, olivine lithium phosphate, a chalcogen compound, and manganese dioxide. Among these, a lithium-containing composite oxide and an olivine lithium phosphate are preferable.

The lithium-containing composite oxide is a metal oxide containing lithium and a transition metal, or an oxide made of such a metal oxide in which the transition metal therein is partly replaced with a different element. For the transition metal, one or more selected from the group consisting of Mn, Fe, Co, and Ni is used. For the different element, a transition metal other than the above (Sc, Y, Cu, Cr, and the like), and an element other than the transition metal (Na, Mg, Zn, Al, Pb, Sb, B, and the like) may be used. Among these, Al and Mg are preferable. One or more different elements may be used.

Examples of the lithium-containing composite metal oxide include LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O₄, LiₓMn₂O₄, and LiₓMn_{2-y}M_{y}O₄ (where M represents at least one element selected from the group consisting of Na, Mg, Sc, Y, Mn, Fe, Co, Ni, Cu, Zn, Al, Cr, Pb, Sb, V, and B. 0<x≦1.2, y=0 to 0.9, z=2.0 to 2.3). Value x represents the molar ratio of lithium increase and decrease with charge and discharge.

Examples of olivine lithium phosphate include LiXPO₄, and Li₂XPO₄ (where X represents at least one selected from the group consisting of Co, Ni, Mn, and Fe). Examples of the chalcogen compound include titanium disulfide, molybdenum disulfide, and the like. The positive electrode active material may be used singly, or may be used in a combination of two or more.

As the conductive agent, those commonly used in the art may be used, including, for example, graphites such as natural graphite and artificial graphite; carbon blacks such as acetylene black, ketjen black, channel black, furnace black, lamp black, and thermal black; conductive fibers such as carbon fiber and metal fiber; powder of a metal such as fluorocarbon and aluminum; conductive whiskers such as zinc oxide; conductive metal oxides such as titanium oxide; and organic conductive materials such as phenylene derivatives. One conductive agent may be used singly, or two or more conductive agents may be used in combination as necessary.

As the binder, those commonly used in the art may be used, including, for example, polyvinylidene fluoride (PVDF), polytetrafluoroethylene (PTFE), polyethylene, polypropylene, aramid resin, polyamide, polyimide, polyamide-imide, polyacrylonitrile, polyacrylic acid, polymethyl acrylate, polyethyl acrylate, polyhexyl acrylate, polymethacrylic acid, polymethyl methacrylate, polyethyl methacrylate, polyhexyl methacrylate, polyvinyl acetate, polyvinylpyrrolidone, polyether, polyether sulphone, polyhexafluoropropylene, styrene-butadiene rubber, an ethylene-propylene diene copolymer, and carboxymethyl cellulose.

For the binder, a copolymer containing two or more monomer compounds may also be used. Examples of the monomer compound include tetrafluoroethylene, perfluoroalkylvinylether, vinylidene fluoride, chlorotrifluoroethylene, ethylene, propylene, hexafluoropropylene, pentafluoropropylene, acrylic acid, methacrylic acid, fluoromethylvinylether, and hexadiene. One binder may be used singly, or two or more binders may be used in combination.

The positive electrode active material layer 11b can be made by applying a positive electrode material mixture slurry on the surface of the positive electrode current collector 11a, drying the slurry, and rolling the slurry as necessary. The positive electrode material mixture slurry can be prepared by dissolving or dispersing the positive electrode active material and, as necessary, a conductive agent and a binder in a solvent. For the solvent, organic solvents such as dimethylformamide, dimethylacetamide, methylformamide, N-methyl-2-pyrrolidone (NMP), dimethylamine, acetone, and cyclohexanone may be used. One solvent may be used singly, or two or more solvents may be used in combination.

When a positive electrode active material, a conductive agent, and a binder are used in combination, their ratios can be appropriately selected. Preferably, the ratio of the positive electrode active material is 80 to 97 wt % relative to the total of the positive electrode active material, the conductive agent, and the binder (hereinafter, referred to as “solid content amount”), the ratio of the conductive agent is 1 to 20 wt % relative to the solid content amount, and the ratio of the binder is 1 to 10 wt % relative to the solid content amount. The amounts may be selected appropriately from the above ranges, so as to make the total of the three components to 100 wt %.

The negative electrode 12 includes a negative electrode current collector 13 and a negative electrode active material layer 14, and the negative electrode active material layer 14 is provided so as to face the positive electrode active material layer 11b of the positive electrode 11 with the separator 15 interposed therebetween. The negative electrode current collector 13 includes, as shown in FIG. 2, a sheet substrate 20 and one or more protrusions 21. On the surfaces of the protrusions 21, columns 25 serving as the columnar active material layer are formed. On a surface 20a of the substrate 20 between one protrusion 21 and another protrusion 21 adjacent thereto, a stacked active material layer 26 in which thin films are stacked in a zigzag manner in the thickness direction is formed.

The substrate 20 is a metal sheet. For the substrate 20, a metal foil, a metal film, and the like can be suitably used. For the material of the substrate 20, stainless steel, nickel, copper, and a copper alloy are preferable. The thickness of the substrate 20 is preferably 1 to 50 μm, more preferably 10 to 40 μm, and particularly preferably 15 to 35 μm.

The protrusions 21 are formed so as to project outwardly from one surface of the substrate 20 in the thickness direction thereof. In this embodiment, a tip end portion (hereinafter, simply called “tip end portion of protrusion 21”) of the protrusion 21 in the direction of its projection is a flat face 21a (hereinafter, referred to as “tip end face 21a”) that is substantially parallel to the surface of the substrate 20. The tip end face 21a preferably has an average surface roughness of 0.3 to 10 μm. Such an average surface roughness further improves the bonding strength between the protrusion 21 and the column 25.

The height of the protrusions 21 is preferably 1 to 20 μm. When the height of the protrusion 21 is below 1 μm, almost the entire surface of the substrate 20 is covered with the alloy-based negative electrode active material when forming the negative electrode active material layer 14. As a result, deformation and the like due to volume changes in the alloy-based negative electrode active material may easily occur in the obtained negative electrode 12. When the height of the protrusions 21 exceeds 20 μm, a stacked active material layer 26 with the desired effects may not be formed.

The height of the protrusions 21 is defined by a cross section of the protrusion 21 in the thickness direction of the substrate 20 (hereinafter, simply called “cross section of protrusion 21”). The thickness direction of the substrate 20 and the thickness direction of the negative electrode current collector 13 are the same. The cross section of the protrusion 21 is a cross section including the furthest tip in the direction of the projection of the protrusion 21. The height of the protrusion 21 is the length of the normal from the furthest tip in the direction of projection of the protrusion 21 to the surface 20a of the substrate 20 in the cross section of the protrusion 21. The height of the protrusion 21 is, for example, obtained by measuring the height of 100 protrusions 21 by observing cross sections of the protrusions 21 with a scanning electron microscope (SEM), and averaging the measured values.

The cross sectional diameter of the protrusion 21 is preferably 5 to 30 μm. When the cross sectional diameter of the protrusion 21 is below 5 μm, the bonding strength between the protrusions 21 and the columns 25 to be mentioned later may decline, and the columns 25 may be separated from the protrusions 21 due to volume changes in the alloy-based negative electrode active material. When the cross sectional diameter of the protrusion 21 exceeds 30 μm, a stacked active material layer 26 with the desired effects may not be formed.

The cross sectional diameter of the protrusion 21 is defined, similarly to the case of the height of the protrusion 21, by a cross section of the protrusion 21. The cross sectional diameter of the protrusion 21 is the longest length in a cross section of the protrusion 21 in the direction parallel to the surface 20a. The cross sectional diameter of the protrusion 21 is obtained by measuring the cross sectional diameter of 100 protrusions 21, and averaging the measured values. It is not necessary that all of the protrusions 21 are formed so as to have the same height or width.

Furthermore, in this embodiment, the protrusions 21 have a circular shape. The shape of the protrusions 21 refer to a shape of the protrusions 21, when viewing the negative electrode current collector 13 from above in the vertical direction while setting the surface 20a of the substrate 20 to coincide with the horizontal plane. The shape of the protrusions 21 is not limited to circular, and may be, for example, a polygon, diamond, or ellipse.

The number of protrusions 21, and the intervals between protrusions 21 are not particularly limited, and are appropriately selected according to the size of the protrusions 21 (height and cross sectional diameter), and the size of the columns 25. The number of the protrusions 21 is, for example, about 10000 to 10000000 per cm². The protrusions 21 are preferably formed so that the axis-to-axis distance between the adjacent protrusions 21 is about 2 to 100 μm.

When the shape of the protrusions 21 is a circle, the axis of the protrusion 21 is an imaginary line going through the center of the circle and extending in the direction perpendicular to the surface 20a. When the circle is not a perfect circle, the axis of the protrusion 21 is an imaginary line that goes through the smallest perfect circle that encloses the circle and extends in the direction perpendicular to the surface 20a. When the shape of the protrusion 21 is a polygon, parallelogram, trapezoid, or diamond, the axis of the protrusion 21 is an imaginary line that goes through the intersection of their diagonal lines, and extends in the direction perpendicular to the surface 20a. When the shape of the protrusion 21 is an ellipse, the axis of the protrusion 21 is an imaginary line that goes through the intersection of the major axis and the minor axis, and extends in the direction perpendicular to the surface 20a.

Although the protrusions 21 are arranged so that the protrusions 21 are staggered on the surface 20a in this embodiment, the arrangement is not limited thereto, and may be arranged regularly, as in a lattice-like arrangement, a closest-packing arrangement, and the like. The protrusions 21 may be arranged irregularly. Furthermore, although the protrusions 21 are formed on one surface of the substrate 20 in the thickness direction thereof in this embodiment, it is not limited thereto, and the protrusions 21 may be formed on both surfaces of the substrate 20 in the thickness direction thereof.

The protrusions 21 are preferably formed by plastic deformation of a metal sheet serving as the substrate 20. In this way, separation of the protrusion 21 from the substrate 20 is significantly suppressed. The plastic deformation is performed, for example, using a protrusion-forming roll. Recess portions corresponding to the shape, size, and arrangement of the protrusions 21 are formed on the surface of the protrusion-forming roll.

When forming the protrusions 21 on one surface of the substrate 20, a metal sheet may be pressure-molded by bringing the protrusion-forming roll and a roll having a smooth surface into pressed contact so as to allow their axes to be parallel, and passing the metal sheet through the pressed contact portion. In this case, the smooth surfaced roll may include a layer of an elastic material at least on its surface.

When forming the protrusions 21 on both surfaces of the substrate 20, a metal sheet may be pressure-molded by bringing two protrusion-forming rolls into pressed contact so as to allow their axes to be parallel, and passing the metal sheet through the pressed contact portion. The pressure of the roll's pressed contact portion is appropriately selected according to the material and the thickness of the metal sheet, the shape and the size of the protrusions 21, the settings for the thickness of the substrate 20 after the pressure-molding and the like.

The protrusion-forming roll may be made, for example, by forming recess portions on the surface of a ceramic roll. For the ceramic roll, those including a core roll and a thermal spray layer may be used. For the core roll, a roll made of iron, stainless steel, and the like can be used. The thermal spray layer can be formed by uniformly thermal-spraying a ceramic material such as chromic oxide on the surface of the core roll. To form the recess portions, for example, a laser generally used for the mold processing of a ceramic material or the like can be used.

A protrusion-forming roll according to another embodiment includes a core roll, a ground layer, and a thermal spray layer. The core roll is the same as the core roll of the ceramic roll. The ground layer is formed on the surface of the core roll. Recess portions are formed on the surface of the ground layer. To form the recess portions on the ground layer, for example, a resin sheet having recess portions on one surface thereof is made, and the resin sheet is bonded to the core roll surface with the face of the resin sheet opposite the face where the recess portions are formed wound around the core roll.

The synthetic resin used for the resin sheet preferably has high mechanical strength. Examples include thermosetting resins such as unsaturated polyester, thermosetting polyimide, epoxy resin, and fluorocarbon resin; and thermoplastic resins such as polyamide and polyetheretherketone. The thermal spray layer is formed by thermal-spraying a ceramic material such as chromic oxide on the surface of the ground layer so as to accord with the projections and recesses. Therefore, the recess portions formed on the ground layer are preferably formed larger than the designed size to the degree of the thickness of the thermal spray layer, considering the thickness of the thermal spray layer.

A protrusion-forming roll according to another embodiment includes a core roll and a hard metal layer. The core roll is the same as the core roll of the ceramic roll. The hard metal layer is formed on the surface of the core roll, and includes a hard metal such as tungsten carbide. The hard metal layer can be formed by thermal fitting or cool fitting the hard metal formed into a cylindrical form on the core roll. In the thermal fitting of the hard metal layer, the cylindrical hard metal is warmed so as to expand, and fitted onto the core roll. In the cool fitting of the hard metal layer, the core roll is cooled so as to shrink, and inserted into the cylindrical hard metal. On the surface of the hard metal layer, recess portions are formed, for example, by laser processing.

In yet another type of projection-forming roll, recess portions are formed on the surface of a hard iron-based roll by, for example, laser processing. A hard iron-based roll, for example, used for making metal foil by rolling is used. An example of the hard iron-based roll may be a roll made of high-speed steel and forged steel. The high-speed steel is an iron-based material with metals such as molybdenum, tungsten, and vanadium being added thereto and heat-treated to increase the hardness. The forged steel is made by heating steel ingots made by casting molten steel in a mold or steel slabs made from steel ingot, forging with presses and hammers or rolling and forging, and further heat-treating the steel ingots or steel slabs.

The negative electrode active material layer 14 includes, as shown in FIG. 3 to FIG. 5, one or more columns 25 serving as the columnar active material layer, and one or more stacked active material layers 26.

The columns 25 are formed so as to extend outwardly from at least a portion of the surface of the protrusions 21, and contain an alloy-based negative electrode active material. The columns 25 are preferably formed so as to extend outwardly from the entire face of the tip end face 21a of the protrusion 21 and a portion of a side face 21b of the protrusion 21. Furthermore, the one or more columns 25 are provided so as to be alienated from each other. Thus, the bonding strength between the columns 25 and the protrusions 21 is further improved. As a result, separation of the column 25 from the protrusions 21 with volume changes in the alloy-based negative electrode active material is more significantly suppressed.

Furthermore, in this embodiment, the columns 25 are formed, as described later, as a stack of chunks containing the alloy-based negative electrode active material. In this way, the size and the shape of the columns 25 are substantially uniform, and the stress generated with volume change in the alloy-based negative electrode active material and added to the protrusions 21 becomes substantially uniform. As a result, deformation of the negative electrode 12 is suppressed. That is, a large stress is not locally added, and the shape of the negative electrode 12 can be maintained easily.

The height of the columns 25 are preferably 5 to 25 μm, and more preferably 10 to 20 μm. Such a height allows the rigidity of the negative electrode active material layer 14 as a whole to be maintained, and damage to the columns 25 during the steps of battery manufacture steps can be prevented. When the height of the columns 25 is below 5 μm, although damage to the columns 25 can be prevented, the output performance of the battery may decline. When the height of the columns 25 exceeds 25 μm, the degree of volume changes in the column 25 becomes excessive, and may easily generate deformation of the negative electrode 12. Furthermore, damage to the columns 25 may become significant, which may cause battery capacity to be insufficient.

The height of the columns 25 refers to the length from the tip end face 21a of the protrusion 21 to the furthest tip end portion of the column 25 in the direction perpendicular to the surface 20a of the substrate 20. The height of the columns 25 is obtained, for example, by observing a cross section of the negative electrode 12 in the thickness direction thereof with a scanning electron microscope, measuring the heights of 100 columns 25, and averaging the measured values.

The diameter of the columns 25 is appropriately selected according to the cross sectional diameter of the protrusion 21 and the axis-to-axis distance of adjacent protrusions 21, but is preferably 10 to 50 μm, and more preferably 15 to 35 μm. With such a diameter, the addition of excessive stress to adjacent columns 25 is suppressed without decreasing battery capacity, even when the columns 25 are expanded to their maximum. As a result, a high capacity battery in which high quality charge and discharge cycle performance is maintained for a long period of time, and that is capable of supplying electric power under high output for a long period of time can be obtained.

When the diameter of the column 25 is below 10 μm, the rigidity of the columns 25 decreases, and the columns 25 may be damaged easily. At the same time, battery capacity may be insufficient. When the diameter of the columns 25 exceeds 50 μm, excessive stress is added to other columns 25 mainly at the time of expansion, which may easily cause deformation of the negative electrode 12, and damage and separation of the columns 25.

The diameter of the column 25 refers to a diameter in the direction parallel to the surface of the substrate 20. The diameter of the columns 25 is obtained by observing the columns 25 from above in a vertical direction with a scanning electron microscope, measuring the maximum diameters of 100 columns 25, and averaging the measured value.

For the alloy-based negative electrode active material contained in the column 25, a material that absorbs lithium by being alloyed with lithium can be used, including, for example, an alloy-based negative electrode active material containing silicon, and an alloy-based negative electrode active material containing tin.

Specific examples of the alloy-based negative electrode active material containing silicon include silicon, a silicon oxide, a silicon nitride, a silicon-containing alloy, and a silicon compound.

For the silicon oxide, a silicon oxide represented by the composition formula SiOₐ (0.05<a<1.95) may be used. For the silicon nitride, a silicon nitride represented by the composition formula SiN_{b} (0<b<4/3) may be used. For the silicon-containing alloy, an alloy containing silicon and an element A other than silicon can be used. For the element A other than silicon, one or more element selected from the group consisting of Fe, Co, Sb, Bi, Pb, Ni, Cu, Zn, Ge, In, Sn, and Ti is preferable. For the silicon compound, for example, a compound in which silicon contained in simple silicon, a silicon oxide, a silicon nitride, or a silicon-containing alloy is partly replaced with an element B other than silicon can be used. For the element B other than silicon, one or more element selected from the group consisting of B, Mg, Ni, Ti, Mo, Co, Ca, Cr, Cu, Fe, Mn, Nb, Ta, V, W, Zn, C, N, and Sn is preferable.

Specific examples of the alloy-based negative electrode active material containing tin include simple tin, a tin oxide, a tin-containing alloy, and a tin compound. For the tin oxide, SnO₂, and a tin oxide represented by the composition formula SnO_{d} (0<d<2) may be used. For the tin-containing alloy, an Ni—Sn alloy, a Mg—Sn alloy, a Fe—Sn alloy, a Cu—Sn alloy, a Ti—Sn alloy, and the like may be used. For the tin compound, SnSiO₃, Ni₂Sn₄, Mg₂Sn, and the like may be used.

Among these, silicon, tin, a silicon oxide, and a tin oxide are preferable, and silicon and a silicon oxide are particularly preferable. The alloy-based negative electrode active material may be used singly, or may be used in combination.

As shown in FIG. 6, the column 25 is formed by stacking eight chunks 25a, 25b, 25c, 25d, 25e, 25f, 25g, and 25h in this embodiment. First, the chunk 25a is formed to cover the entire face of the tip end face 21a of the protrusion 21, and then a portion of the side face 21b continuing therefrom. Next, the chunk 25b is formed so as to cover a portion of the remaining side face 21b of the protrusion 21, and a portion of the top surface of the chunk 25a.

That is, in FIG. 6, the chunk 25a is formed at one edge of the protrusion 21 that includes the tip end face 21a, and a portion of the chunk 25b is stacked on the chunk 25a but the remaining portion is formed at the other edge of the protrusion 21. Furthermore, the chunk 25c is formed so as to cover the remaining portion of the top surface of the chunk 25a, and a portion of the top surface of the chunk 25b. That is, the chunk 25c is formed to mainly contact with the chunk 25a. Furthermore, the chunk 25d is mainly formed on the surface of the chunk 25b. Afterwards, by stacking the chunks 25e, 25f, 25g, and 25h alternately in the same manner, the column 25 is formed. Although eight chunks are stacked in this embodiment, the number of the chunks is not limited thereto, and a plural number of chunks can be stacked arbitrarily.

The stacked active material layer 26 is formed as a stack in which a thin film 26a is stacked in a zigzag manner on the substrate surface 20b in the thickness direction thereof, as shown in FIG. 4 and FIG. 5. A first thin film 26a is formed in a predetermined direction, and then a next thin film 26a to be stacked is formed in the reverse direction of the direction with which the first thin film 26a is formed. Afterwards, the thin film 26a is stacked in the same manner, alternately with the reverse forming directions. The thin film 26a contains the alloy-based negative electrode active material. The alloy-based negative electrode active material is the same as that included in the column 25. The substrate surface 20b is a surface of the substrate 20 between one protrusion 21 and another protrusion 21 that is adjacent thereto.

By stacking the thin film 26a containing the alloy-based negative electrode active material in a zigzag manner, an improvement in the properties of the bonding between the stacked active material layer 26 and the negative electrode current collector 13, and the prevention of deformation (buckling) of the negative electrode current collector 13 can be simultaneously achieved to a high standard. Although the reasons why such effects can be obtained are not sufficiently clear, the following can be assumed.

That is, expansion and contraction of the alloy-based negative electrode active material becomes substantially uniform throughout the entire stacked active material layer 26, and the stress that is generated therewith becomes substantially uniform. Furthermore, the thin film 26a is stacked in a zigzag manner in the stacked active material layer 26, and the direction of the deposition of the alloy-based negative electrode active material reverses for every thin film 26a. Thus, the direction with which stress is added with volume changes also reverses, and stress for the entire stacked active material layer 26 is eased. As a result, reinforcing effects that maintain the shape of the negative electrode current collector 13 become larger than the stress that causes the negative electrode current collector 13 to deform. Thus, deformation (buckling) of the negative electrode current collector 13 is significantly suppressed, and separation of the stacked active material layer 26 from the negative electrode current collector 13 is suppressed as well. As a result, charge and discharge efficiency improves, and a battery that can maintain a high output for a long period of time is obtained. Such a battery is capable of serving even very high output demands in a very short period of time.

The thickness of the stacked active material layer 26 is preferably 1 to 5 μm, and more preferably 2 to 3 μm. With such a thickness, the properties of the bonding between the negative electrode current collector 13 and the column 25 improve and, therefore, battery capacity does not easily decrease even if charge and discharge are repeatedly carried out. Furthermore, by forming the thin film 26a in a zigzag manner, deformation of the current collector 13 and even the negative electrode 12 can be prevented.

When the thickness of the stacked active material layer 26 is below 1 μm, although it is effective in preventing deformation of the negative electrode 12, the properties of the bonding between the columns 25 and the current collector 13 may be insufficient. As a result, with repeated charge and discharge, battery capacity may easily decrease. When the thickness of the stacked active material layer 26 exceeds 5 μm, there is a possibility that stress is generated at the time of expansion between the stacked active material layer 26 and the columns 25. Such a stress may possibly cause the columns 25 and the stacked active material layer 26 to separate from the negative electrode current collector 13, and may also cause deformation of the negative electrode 12.

The thickness of the stacked active material layer 26 is the thickness of the stacked active material layer 26 at the midpoint between the axis of a protrusion 21 and the axis of a protrusion 21 adjacent thereto. The thickness refers to the length from the surface 20b to the upper end of the stacked active material layer 26 in the direction perpendicular to the surface 20b of the substrate 20. The thickness of the stacked active material layer 26 is obtained, for example, by observing a cross section of the negative electrode 12 in the thickness direction thereof with a scanning electron microscope, measuring the thicknesses of 100 stacked active material layers 26, and averaging the measured values.

The stacked active material layer 26 is formed simultaneously with the columns 25. To form the columns 25 and the stacked active material layer 26 simultaneously, it is necessary that one or more of the following is appropriately adjusted: the height and the cross sectional diameter of the protrusions 21, the axis-to-axis distance between a protrusion 21 and another protrusion 21 adjacent thereto, and the incident angle (here, angle α°) of a vapor of the alloy-based negative electrode active material to be mentioned later relative to the negative electrode current collector 13.

For example, the height of the protrusion 21 is preferably selected from the range of 3 to 10 μm, and more preferably from the range of 5 to 8 μm. The cross sectional diameter of the protrusion 21 is preferably selected from the range of 5 to 30 μm, and more preferably selected from the range of 15 to 25 μm. The axis-to-axis distance is preferably selected from the range of 10 to 30 μm, and more preferably from the range of 15 to 25 μm. The incident angle is preferably selected from the range of 45 to 85°, and more preferably selected from the range of 55 to 75°. When values outside these ranges are used, a stacked active material layer 26 that brings out their functions sufficiently may not be formed.

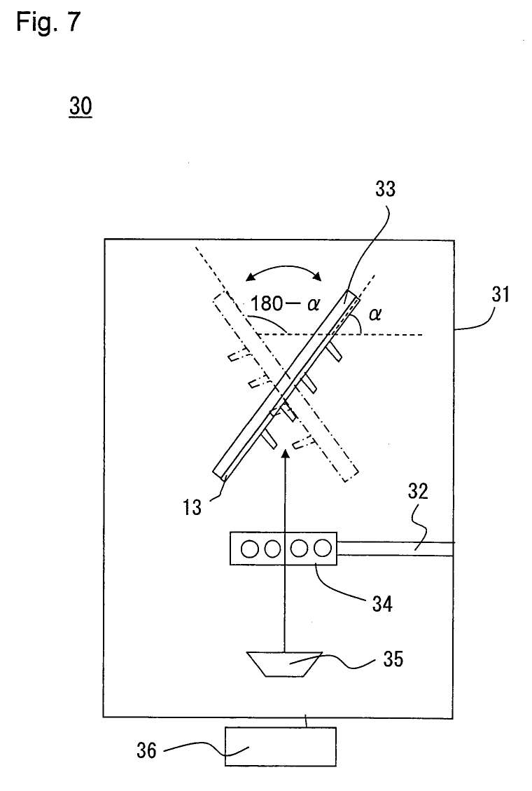

The columns 25 and the stacked active material layer 26 can be formed, for example, using an electron beam deposition apparatus 30 shown in FIG. 7. FIG. 7 is a side view schematically illustrating the configuration of the electron beam deposition apparatus 30. In FIG. 7, solid lines are used to illustrate the members in the deposition apparatus 30. The deposition apparatus 30 includes a chamber 31, a first pipe 32, a fixing board 33, a nozzle 34, a target 35, an electron beam generating apparatus (not shown), a power source 36, and a second pipe (not shown).

The chamber 31 is a pressure-tight container having an inner space, and contains the first pipe 32, the fixing board 33, the nozzle 34, and the target 35 therein. One end of the first pipe 32 is connected to the nozzle 34, and the other end extends to the outside of the chamber 31, and is connected to an ingredient gas cylinder or an ingredient gas producing apparatus (not shown) via a mass flow controller (not shown). For the ingredient gas, oxygen, nitrogen, and the like may be used. The first pipe supplies the ingredient gas to the nozzle 34.

The fixing board 33 is a rotatably supported plate-like member, and the negative electrode current collector 13 can be fixed to one face of the fixing board 33 in the thickness direction thereof. The fixing board 33 is rotated between the position indicated by the solid lines and the position indicated by the dash-dotted lines in FIG. 7. The position indicated by the solid lines is a position at which the surface of the fixing board 33 on which the negative electrode current collector 13 is fixed faces the nozzle 34 located vertically below the board and the angle of the fixing board 33 relative to the line in the horizontal direction is α°. The position indicated by the dash-dotted lines is a position at which the surface of the fixing board 33 on which the negative electrode current collector 13 is fixed faces the nozzle 34 located vertically below the board and the angle of the fixing board 33 relative to the line in the horizontal direction is (180−α)°.

The nozzle 34 is provided between the fixing board 33 and the target 35 along the vertical direction, and is connected to one end of the first pipe 32. The nozzle 34 allows the vapor of the alloy-based negative electrode active material moving upward in the vertical direction from the target 35 to be mixed with the ingredient gas supplied from the first pipe 32, and supplies the mixture to the surface of the negative electrode current collector 13 fixed onto the surface of the fixing board 33.

The target 35 holds the alloy-based negative electrode active material or an ingredient thereof. The electron beam generating apparatus applies an electron beam to the alloy-based negative electrode active material or the ingredients of the alloy-based negative electrode active material held in the target 35, thereby heating and generating a vapor thereof.

The power source 36 is provided outside the chamber 31, and applies a voltage to the electron beam generating apparatus. The electron beam generating apparatus thus generates an electron beam. The second pipe introduces a gas that forms the atmosphere of the chamber 31.

An electron beam deposition apparatus having the same configuration as that of the deposition apparatus 30 is commercially available from, for example, Ulvac Inc.

In the electron beam deposition apparatus 30, first of all, the negative electrode current collector 13 is fixed to the fixing board 33, and oxygen gas is introduced into the chamber 31. In this state, an electron beam is applied to the alloy-based negative electrode active material or the ingredients of the alloy-based negative electrode active material in the target 35, thereby heating and generating a vapor thereof. In this embodiment, silicon is used as the alloy-based negative electrode active material. The generated vapor goes up in the vertical direction, and is mixed with the ingredient gas upon passing through the proximity of the nozzle 34. The mixed gas goes up further to be supplied to the surface of the negative electrode current collector 13 fixed onto the fixing board 33. A layer including silicon and oxygen on the surface of the protrusions 21 (not shown) is thus formed.

At this time, by setting the fixing board 33 to the position indicated by the solid lines, the chunk 25a shown in FIG. 6 is formed on the surface of the protrusion 21. Subsequently, by rotating the fixing board 33 to the position indicated by the dash-dotted lines, the chunk 25b shown in FIG. 6 is formed. By rotating the fixing board 33 in this way to reach the positions alternately, the column 25, i.e., the stack of the eight chunks 25a to 25h shown in FIG. 6, is formed on the surface of the protrusion 21. Alongside, the stacked active material layer 26 in which the thin film 26a is stacked in a zigzag manner in the thickness direction is formed on the substrate surface 20b.

When the negative electrode active material is a silicon oxide represented by, for example, SiOₐ (0.05<a<1.95), the column 25 and the stacked active material layer 26 may be formed so as to provide an oxygen concentration gradient in the thickness direction of the negative electrode 12. To be specific, the oxygen content may be increased in the proximity of the negative electrode current collector 13, and may be reduced as the distance from the current collector 13 increases. In this way, the bonding strength between the negative electrode current collector 13 and the columns 25, and the stacked active material layer 26 further improves.

When the ingredient gas is not supplied from the nozzle 34, a column 25 and a stacked active material layer 26, mainly composed of silicon or simple tin are formed.

A lithium metal layer may further be formed on the surface of the negative electrode active material layer 14, when the negative electrode 12 is to be used in a lithium ion secondary battery. At this time, the amount of lithium metal may be set to the amount corresponding to the irreversible capacity stored in the negative electrode active material layer 14 at the time of initial charge and discharge. The lithium metal layer can be formed, for example, by vapor deposition.

Referring back to FIG. 1, the separator 15 is provided so as to be interposed between the positive electrode 11 and the negative electrode 12. For the separator 15, a porous sheet having a predetermined ion permeability, mechanical strength, and nonconductivity is used. For the porous sheet, microporous film, woven fabric, and nonwoven fabric may be used. The microporous film may be any of a single-layer film and a multi-layer film (composite film). The single-layer film is composed of one type of material. The multi-layer film (composite film) is a stack of the single-layer film composed of one type of material or a stack of single-layer films composed of different materials. As necessary, the separator 15 may be formed by two or more stacks of, for example, the microporous film, the woven fabric, or the nonwoven fabric.

Although various resin materials may be used for the materials of the separator 15, in view of durability, shutdown function, and battery safety, polyolefins such as polyethylene and polypropylene are preferable. Although the thickness of the separator 15 is generally 10 to 300 μm, preferably, the thickness is 10 to 40 μm, more preferably 10 to 30 μm, and still more preferably 10 to 25 μm. The porosity of the separator 15 is preferably 30 to 70%, and more preferably 35 to 60%. The porosity is the ratio by percentage of the total volume of pores (micropores) present in the separator 15 relative to the volume of the separator 15.

The separator 15 is impregnated with an electrolyte that has lithium ion conductivity. The electrolyte that has lithium ion conductivity is preferably a non-aqueous electrolyte having lithium ion conductivity. Examples of the non-aqueous electrolyte include a liquid non-aqueous electrolyte, a gelled non-aqueous electrolyte, and a solid electrolyte (for example, polymer solid electrolyte).

The liquid non-aqueous electrolyte contains a solute (supporting salt) and a non-aqueous solvent, and further contains various additives as necessary. The solute is generally dissolved in the non-aqueous solvent.

For the solute, those commonly used in the art may be used, including, for example, LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylates, LiCl, LiBr, LiI, LiBCl₄, borates, and imide salts.

Examples of the borates include bis(1,2-benzenedioleate (2-)-O,O′) lithium borate, bis(2,3-naphthalenedioleate (2-)-O,O′) lithium borate, bis(2,2′-biphenyldioleate (2-)-O,O′) lithium borate, and bis(5-fluoro-2-olate-1-benzenesulfonic acid-O,O′) lithium borate.

Examples of the imide salts include lithium bistrifluoromethanesulfonate imide ((CF₃SO₂)₂NLi), lithium trifluoromethanesulfonate nonafluorobutanesulfonate imide ((CF₃SO₂) (C₄F₉SO₂)NLi), and lithium bispentafluoroethanesulfonate imide ((C₂F₅SO₂)₂NLi).

One of the solutes may be used singly or, as necessary, two or more of the solutes may be used in combination. The amount of solute to be dissolved in the non-aqueous solvent is preferably in the range of 0.5 to 2 mol/L.

For the non-aqueous solvent, those commonly used in the art may be used, including, for example, cyclic carbonates, chain carbonates, and cyclic carboxylates. Examples of the cyclic carbonates include propylene carbonate (PC) and ethylene carbonate (EC). Examples of the chain carbonates include diethyl carbonate (DEC), ethyl methyl carbonate (EMC), and dimethyl carbonate (DMC). Examples of the cyclic carboxylates include γ-butyrolactone (GBL) and γ-valerolactone (GVL). One of the non-aqueous solvents may be used singly, or two or more of them may be used in combination.

Examples of the additives include an additive X and an additive Y. The additive X improves the charge and discharge efficiency by, for example, decomposing on the negative electrode to form a coating with high lithium ion conductivity. Specific examples of such additives include vinylene carbonate (VC), 4-methylvinylene carbonate, 4,5-dimethylvinylene carbonate, 4-ethylvinylene carbonate, 4,5-diethylvinylene carbonate, 4-propylvinylene carbonate, 4,5-dipropylvinylene carbonate, 4-phenylvinylene carbonate, 4,5-diphenylvinylene carbonate, vinyl ethylene carbonate (VEC), and divinyl ethylene carbonate. These may be used singly, or may be used in a combination of two or more. Among these, at least one selected from the group consisting of vinylene carbonate, vinyl ethylene carbonate, and divinyl ethylene carbonate is preferable. In the above-described compounds, the hydrogen atoms may be partially replaced with fluorine atoms.

The additive Y makes a battery inactive by, for example, decomposing at the time of battery overcharge, to form a coating on the surface of the electrode. Examples of such additives include benzene derivatives. Such benzene derivatives include a benzene compound containing a phenyl group and a cyclic compound group adjacent to the phenyl group. For the cyclic compound group, for example, a phenyl group, a cyclic ether group, a cyclic ester group, a cycloalkyl group, and a phenoxy group are preferable. Specific examples of the benzene derivatives include cyclohexyl benzene, biphenyl, and diphenylether. The benzene derivatives may be used singly, or may be used in a combination of two or more. However, the benzene derivative content in the liquid non-aqueous electrolyte is preferably 10 parts by volume or less relative to 100 parts by volume of the non-aqueous solvent.

The gelled non-aqueous electrolyte includes a liquid non-aqueous electrolyte and a polymer material for holding the liquid non-aqueous electrolyte. Here, the polymer material used is a material that is capable of gelling a liquid. For the polymer material, those commonly used in the art may be used, including, for example, polyvinylidene fluoride, polyacrylonitrile, polyethylene oxide, polyvinyl chloride, polyacrylate, and polymethacrylate.

The solid electrolyte includes, for example, a solute (supporting salt) and a polymer material. As the solute, those previously described as examples may be used. Examples of the polymer material include polyethylene oxide (PEO), polypropylene oxide (PPO), and a copolymer of ethylene oxide and propylene oxide.

One end of the positive electrode lead 16 is connected to a portion of the positive electrode current collector 11a where the positive electrode active material layer 11b is not formed, and the other end of the positive electrode lead 16 is drawn out from an opening 19a of the outer case 19 to the outside of the lithium ion secondary battery 1. For the positive electrode lead 16, those commonly used in the technical field of lithium ion secondary batteries can be used, for example, an aluminum lead.

One end of the negative electrode lead 17 is connected to a portion of the negative electrode current collector 13 where the negative electrode active material layer 14 is not formed, and the other end of the negative electrode lead 17 is drawn out from an opening 19b of the outer case 19 to the outside of the lithium ion secondary battery 1. For the negative electrode lead 17, those commonly used in the technical field of lithium ion secondary batteries can be used, for example, a nickel lead.

The gasket 18 is used to seal the openings 19a and 19b of the outer case 19. For the gasket 18, for example, those made of various synthetic resins can be used. The openings 19a and 19b of the outer case 19 may be directly sealed by welding and the like without using the gasket 18.

The outer case 19 is a container having openings 19a and 19b at both ends thereof. An outer case having an opening only at one end may be used. Examples of the material forming the outer case 19 include a laminate film, a metal, and a synthetic resin.

The lithium ion secondary battery 1 can be made, for example, as follows. First, one end of the positive electrode lead 16 is connected to the positive electrode 11. One end of the negative electrode lead 17 is connected to the negative electrode 12. Then, the positive electrode 11 and the negative electrode 12 are stacked with the separator 15 interposed therebetween, thereby producing an electrode assembly. This electrode assembly is inserted into the outer case 19 and the other ends of the positive electrode lead 16 and the negative electrode lead 17 are brought out of the outer case 19. A non-aqueous electrolyte is injected in the outer case 19, under a reduced pressure as necessary. With a reduced pressure inside the outer case 19, the gaskets 18 are placed at the openings 19a and 19b and the gaskets 18 and the outer case are welded, thereby sealing the openings 19a and 19b.

Although a lithium ion secondary battery 1 having a stack-type electrode assembly is described in this embodiment, the present invention is not limited thereto, and a wound-type electrode assembly may also be used in the lithium ion secondary battery. The wound-type electrode assembly is made by winding the positive electrode and the negative electrode with the separator interposed therebetween.

The lithium ion secondary battery of the present invention may be formed into an arbitrary shape, for example, a film-type, a coin-type, a prism-type, a cylindrical-type, and a flat-type.

The lithium ion secondary battery of the present invention can be used in a similar way to conventional lithium ion secondary batteries, particularly, as a power source for portable electronic devices. Such portable electronic devices include, for example, personal computers, mobile phones, mobile devices, personal digital assistants (PDAs), mobile game machines, and camcorders. Expected applications also include a secondary battery assisting an electric motor in hybrid electric vehicles and fuel cell cars; a power source for driving, for example, electrically-powered tools, vacuum cleaners, and robots; and a power source for plug-in HEVs.

### EXAMPLES

The present invention is described in detail in the following Examples, Comparative Examples, and Test Examples.

### Example 1

### (1) Positive Electrode Active Material Preparation

Cobalt sulfate and aluminum sulfate were added to an aqueous solution of NiSO₄ such that Ni:Co:Al=7:2:1 (molar ratio) was satisfied, thereby preparing an aqueous solution having a metal ion concentration of 2 mol/L. To this aqueous solution, a 2 mol/L sodium hydroxide solution was dropped gradually while stirring to neutralize, thereby producing, by co-precipitation, a ternary precipitate having a composition represented by Ni_{0.7}Co_{0.2}Al_{0.1}(OH)₂. This precipitate was separated by filtration, washed with water, and dried at 80° C., thereby obtaining a composite hydroxide. As a result of measuring the average particle size of the obtained composite hydroxide with a particle size distribution meter (product name: MT 3000, manufactured by Nikkiso Co., Ltd.), it was found that the average particle size was 10 μm.

This composite hydroxide was heated in air at 900° C. for 10 hours, thereby obtaining a ternary composite oxide having a composition represented by Ni_{0.7}Co_{0.2}Al_{0.1}O. At this time, lithium hydroxide monohydrate was added so as to equalize the total number of Ni, Co, and Al atoms, and the number of Li atoms, and the resultant was heated in air at 800° C. for 10 hours, thereby obtaining a lithium-nickel-containing composite metal oxide having a composition represented by LiNi_{0.7}Co_{0.2}Al_{0.1}O₂. As a result of analyzing this lithium-containing composite metal oxide by powder X-ray diffraction, it was confirmed that it had a single phase, hexagonal crystal layer structure, and Co and Al were incorporated as a solid solution. Thus, a positive electrode active material including secondary particles having an average particle size of 10 μm and a specific surface area of 0.45 m²/g according to the BET method was obtained.

### (2) Positive Electrode Preparation

A positive electrode material mixture paste was prepared by sufficiently mixing 100 g of the obtained positive electrode active material powder, 3 g of acetylene black (conductive agent), 3 g of polyvinylidene fluoride powder (binder), and 50 ml of N-methyl-2-pyrrolidone (NMP). This positive electrode material mixture paste was applied to both sides of an aluminum foil (positive electrode current collector) with a thickness of 20 μm, dried, and rolled, thereby forming a positive electrode active material layer. Afterwards, the obtained positive electrode plate was cut, thereby producing a positive electrode with a size of 30 mm×200 mm, in which the thickness of the active material layer on one side thereof is 50 μm.

### (3) Negative Electrode Preparation

A ceramic layer with a thickness of 100 μm was formed by thermal spraying chromic oxide onto the surface of an iron roll with a diameter of 50 mm. A projection-forming roll was made by forming holes, i.e., circular recesses, with a diameter of 20 μm and a depth of 7 μm, on the surface of this ceramic layer by laser processing. These holes were arranged to form a close-packed structure, with a distance between the axes of adjacent holes of 40 μm. The bottoms of these holes were substantially planar at their center, and a portion connecting the periphery of the bottom with the side face was formed so as to be rounded off.

Alloy copper foil (product name: HCL-02Z, thickness 20 μm, manufactured by Hitachi Cable) containing 0.03 wt % zirconia relative to the total amount was heated in an argon gas atmosphere at 600° C. for 30 minutes to anneal. This alloy copper foil was allowed to pass through a pressed contact portion where the two projection-forming rolls were brought into pressed contact with each other while applying a line pressure of 2 t/cm to pressure-mold both sides of the alloy copper foil, thereby making a negative electrode current collector for use in the present invention. As a result of observing the cross section of the obtained negative electrode current collector in the thickness direction thereof with a scanning electron microscope, it was found that protrusions were formed on the surface of the negative electrode current collector. The protrusions had a substantially circular shape, an average height of about 6 μm, an average cross sectional diameter of about 20 μm, and an average axis-to-axis distance between protrusions of about 40 μm.

The columnar active material layer and the stacked active material layer were formed on the surface of the negative electrode current collector by using a commercially available deposition apparatus (manufactured by ULVAC, Inc.) having the same structure as that of the electron beam vapor deposition apparatus 30 shown in FIG. 7. The conditions for the deposition were as follows. The fixing board on which the negative electrode current collector with a size of 35 mm×205 mm was fixed was set such that the fixing board was rotated between a position at an angle α of 60° (the position shown by solid lines in FIG. 7) and a position at an angle of (180−α)=120° (the position shown by dash-dotted lines shown in FIG. 7) with respect to the straight line in the horizontal direction in an alternating manner. In this way, columns in which the chunks were stacked in eight layers as shown in FIG. 6 serving as the columnar active material layer were formed. At the same time, a stacked active material layer in which thin films were stacked in a zigzag manner between one protrusion and another protrusion was formed. The negative electrode of the present invention was thus made.

Negative Electrode Active Material Ingredient (Evaporation Source): silicon, 99.9999% purity, manufactured by Kojundo Chemical Laboratory Co., Ltd.
Angle α: 60°
Electron beam accelerating voltage: −8 kV
Emission: 500 mA
Vapor deposition time: 3 minutes

The thickness (height) of the columns was 10 μm, and the thickness of the stacked active material layer in which the active material thin films were stacked in a zigzag manner was 3 μm. The thickness of the columns was obtained by observing the cross section of the negative electrode in the thickness direction thereof with a scanning electron microscope, measuring the length from the vertex of the protrusion of the negative electrode current collector to the column vertex for ten columns formed on the protrusion surface, and averaging the ten measured values for the ten columns. The thickness of the active material layer was obtained by measuring the thickness of the stacked active material layer at the midpoint of the axes of adjacent protrusions at ten points, and averaging the measured values.

### (4) Wound-Type Battery Preparation

One end of the aluminum positive electrode lead was connected to the obtained positive electrode where the current collector was exposed. Also, one end of the nickel negative electrode lead was connected to the obtained negative electrode where the current collector was exposed. The positive electrode, a polyethylene porous film, and the negative electrode were stacked so that the positive electrode active material layer and the negative electrode active material layer faced each other with the polyethylene porous film (separator, product name: Hipore, thickness 20 μm, manufactured by Asahi Kasei Corporation) interposed therebetween. The stack of positive electrode, polyethylene porous film, and negative electrode was wound and molded into a flat plate, thereby making a flat wound-type electrode assembly. The positive electrode lead and the negative electrode lead were connected so that the leads were parallel to the wounding axis direction of the wound-type electrode assembly.

The wound-type electrode assembly was inserted into an outer case of an aluminum laminate sheet, and an electrolyte was injected. For the electrolyte, a non-aqueous electrolyte in which LiPF₆ was dissolved in a mixed solvent of a 1:1 volume ratio of ethylene carbonate (EC) and ethyl methyl carbonate (EMC) at a concentration of 1.0 mol/L was used. Then, the positive electrode lead and the negative electrode lead were brought out from the openings of the outer case to the outside of the outer case, and while reducing the pressure in the outer case under vacuum, the openings of the outer case were welded, and the lead projecting from the outer case was cut to give a length of 1 cm, thereby making an uncharged lithium ion secondary battery of the present invention.

### Comparative Example 1

A lithium ion secondary battery was made in the same manner as Example 1, except that a negative electrode made as follows was used.

### [Negative Electrode Preparation]

A negative electrode active material layer was formed using a commercially available deposition apparatus (manufactured by ULVAC, Inc.) having the same configuration as that of the electron beam deposition apparatus 30 shown in FIG. 7. The conditions for the deposition were as follows. The fixing board to which the negative electrode current collector with a size of 35 mm×205 mm was fixed was allowed to coincide with the horizontal plane (angle α=0°). Then, a silicon film with a thickness of about 3 μm was formed in a non-zigzag manner on the entire face of the negative electrode current collector. This silicon film had a substantially uniform structure throughout.

Next, the fixing board was set such that the fixing board was rotated between a position at an angle α=60° (the position shown by solid lines in FIG. 7) and a position at an angle (180−α)=120° (the position shown by dash-dotted lines in FIG. 7) with respect to the straight line in the horizontal direction in an alternating manner. Then, columns in which the chunks were stacked in eight layers were formed on the surface of the silicon film, with the same conditions as those of Example 1. The thickness of the negative electrode active material layer, i.e., the total of the thickness of the silicon film and the height of the columns, was about 10 μm. In this case, the height of the columns is the length from the surface of the silicon film to the tip end portion of the columns. Thus, a negative electrode of Comparative Example 1 was made.

### Test Example 1

### [Battery Capacity Evaluation]

A charge and discharge cycle was repeated a total of three times with the conditions below for the lithium ion secondary batteries of Example 1 and Comparative Example 1, and the discharge capacity for the third time was obtained. The results are shown in Table 1.

Constant Current Charge: 280 mA (0.7 C), End Voltage 4.2 V.

Constant Voltage Charge: End Current 20 mA (0.05 C), Pause Period 20 minutes.

Constant Current Discharge: Electric Current 80 mA (0.2 C), End Voltage 2.5 V, Pause Period 20 minutes.

### [Charge and Discharge Cycle Performance Evaluation]

The battery was charged with a constant current of 280 mA (0.7 C) in an environment at 20° C. until 4.2 V, then charged with a constant current to the end current of 20 mA (0.05 C), and discharged at a constant current of 80 mA (0.2 C) to 2.5 V. The discharge capacity at this time was regarded as the initial discharge capacity. Afterwards, a charge and discharge cycle was repeated with a current value of 400 mA (1 C) at the time of discharging and, after 100 cycles, constant current discharge was performed at 80 mA (0.2 C): This was regarded as the discharge capacity after 100 cycles. Then, the ratio of the discharge capacity after 100 cycles relative to the initial discharge capacity was obtained as the cycle capacity retention rate (%). The results are shown in Table 1.

### [Battery Swelling Evaluation]

Before evaluating charge and discharge cycle performance, the thickness of the electrode assembly was measured, and the thickness was regarded as the electrode assembly thickness before evaluation. In the evaluation of charge and discharge cycle performance, the electrode assembly was removed from the battery that went through 100 cycles, and the thickness of the electrode assembly was measured. The thickness was regarded as the electrode assembly thickness after 100 cycles. The electrode assembly thickness before evaluation was deducted from the electrode assembly thickness after 100 cycles, and the resultant value (amount of increase in thickness) was regarded as battery swelling. The results are shown in Table 1.

TABLE 1

| | | Charge and | |
|---|---|---|---|
| | Battery | Discharge Cycle | |
| | Capacity | Performance | Battery |
| | Evaluation | Evaluation | Swelling |
| | Discharge | Cycle Capacity | Increase in |
| | Capacity | Retention Rate | Thickness |
| | (mAh) | (%) | (mm) |
| Example 1 | 406 | 80 | 0.5 |
| Comparative | 408 | 70 | 1.8 |
| Example 1 | | | |

Based on Table 1, it is clear that by using the configuration of the present invention, a lithium ion secondary battery that has a high battery capacity, and is capable of maintaining high quality charge and discharge cycle performance for a long period of time can be obtained.

Also, the battery after evaluation of charge and discharge cycle performance was disassembled, and the negative electrode was removed therefrom. The presence or absence of negative electrode deformation was checked visually. As a result, no negative electrode deformation was observed with the naked eye in the battery of Example 1. In contrast, negative electrode deformation was observed with the naked eye in the battery of Comparative Example 1.

Next, the negative electrode of each example was cut in the thickness direction, and the interface between the negative electrode active material layer and the negative electrode current collector was observed with a microscope. As a result, it was found that the bonding state between the negative electrode active material layer and the negative electrode current collector was excellent, and only very minor separation of the negative electrode active material layer was sporadically present in the negative electrode of the battery of Example 1. In contrast, in the negative electrode of the battery of Comparative Example 1, significant separation of the negative electrode active material layer was observed more and, other than such separation, current collector deformation, and the removal of fragments of the negative electrode active material layer was observed.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A negative electrode comprising a negative electrode current collector and a negative electrode active material layer,
wherein said negative electrode current collector includes a sheet substrate and a plurality of protrusions, said protrusions being formed to project outwardly from at least one surface of said substrate,
said negative electrode active material layer includes a columnar active material layer and a stacked active material layer,
said columnar active material layer includes an alloy-based negative electrode active material, and is formed so as to extend outwardly from at least a portion of the surface of said protrusions, and
said stacked active material layer is formed by stacking an active material thin film including an alloy-based negative electrode active material in a zigzag manner on the surface of said substrate between said protrusions that are adjacent to each other.

2. The negative electrode in accordance with claim 1, wherein said columnar active material layer is formed so as to extend outwardly from at least the entire face of a tip end portion of said protrusions and a portion of a side face of said protrusions.

3. The negative electrode in accordance with claim 1, wherein said columnar active material layer is a stack of chunks including said alloy-based negative electrode active material.

4. The negative electrode in accordance with claim 1, wherein said protrusions are formed by plastic deformation of a metal sheet.

5. The negative electrode in accordance with claim 1, wherein a tip end portion of said protrusions in the direction of their projection is a flat face substantially parallel to the surface of said substrate.

6. The negative electrode in accordance with claim 1, wherein a height of said protrusions is 1 to 20 μm, and a cross sectional diameter of said protrusions is 5 to 30 μm.

7. The negative electrode in accordance with claim 1, wherein said alloy-based negative electrode active material is at least one selected from the group consisting of an alloy-based negative electrode active material including silicon, and an alloy-based negative electrode active material including tin.

8. The negative electrode in accordance with claim 7, wherein said alloy-based negative electrode active material including silicon is at least one selected from the group consisting of silicon, a silicon oxide, a silicon nitride, a silicon-containing alloy, and a silicon compound.

9. The negative electrode in accordance with claim 7, wherein said alloy-based negative electrode active material including tin is at least one selected from the group consisting of tin, a tin oxide, a tin-containing alloy, and a tin compound.

10. A lithium ion secondary battery comprising a positive electrode, a negative electrode, a separator, and a non-aqueous electrolyte,
wherein said positive electrode includes a positive electrode active material capable of absorbing and desorbing lithium,
said negative electrode is the negative electrode in accordance with claim 1,
said separator is disposed so as to be interposed between said positive electrode and said negative electrode, and
said non-aqueous electrolyte has lithium ion conductivity.
